(19) United States
(12) Patent Application Publication
(10) Pub. No.: US 2017/0124913 A1
(43) Pub. Date: May 4, 2017

(54) THREADING SUBSTRATE

(71) Applicant: Adina Levin, New York, NY (US)

(72) Inventor: Adina Levin, New York, NY (US)

(21) Appl. No.: 14/930,007

(22) Filed: Nov. 2, 2015

(51) Int. Cl. G09B 19/20

(52) U.S. Cl. CPC G09B 19/20

(57) ABSTRACT

The present technology is directed to apparatuses and methods for threading or lacing an article with a filament.

### TECHNICAL FIELD

The present technology relates generally to apparatuses and methods for threading an article with filament.

### BACKGROUND

Lacing cards are known in the arts and crafts community as well as for children learning fine motor skills. They typically consist of a substrate or article having a substantially planar surface with holes or bores provided for lacing a filament through. The holes provide a path or pattern to be created by lacing the filament across the article. Besides being used for crafts and as a learning tool, there are also other uses for these threading articles including, for example, guides for wires and templates for lighting designs.

Common materials used for the substrates or articles are cardboard, paper, wood, rubber, metals and plastics, or combinations of those. Common filaments used include cotton, jute, fiber, wool, rubber, metal, plastic, glass, leather, string, twine, thread, yarn, wire and rope. The articles can be flat but can also be curved or angled. They can be of open or closed shape.

A problem associated with these articles is that holes or bores need to be created to allow for a path or pattern for the filament. These holes can be difficult or inconvenient to make at the time a user desires. Therefore, manufacturers must fabricate articles with the holes already made, thereby limiting the patterns available to only those that are provided by the manufacturer. Alternatively, a user can create holes in an article on his or her own, but only with some effort and the appropriate tool for the material. Common means for making such holes include paper hole punches, drills, awls and lasers. This limits a user's ability to make creative patterns of his or her own design.

Thus, it is desirable for a user to have the ability to make clean, clear hole paths in an article in patterns determined at the time of lacing (rather than at the time of manufacture), without the use of special tools and without damaging or marking the article surface.

### SUMMARY

In certain embodiments, the present technology is directed to an article comprising a first fascia and a second fascia; each of the first fascia and the second fascia being thin enough to provide for the transmission of a lace therethrough by user pressure without the need for any tools; each of the first and the second fascia being disposed at least partially over a body comprising a hole; wherein the first fascia at least partially covers a first side of the body and the second fascia at least partially covers a second side of the body opposite the first side of the body. In certain embodiments, a second fascia is unnecessary when the first fascia is able to cover some or all of the body.

In certain embodiments, the present technology is directed to a method of lacing an article by inserting a lace through a first facia at a point over a hole in a first side of a body and out of a second facia on the other side of the body at a point over the hole. The fascia is thin enough to provide for the transmission of a lace through the fascia portions that lie over the hole in the body through user pressure without the need for any tools. The lace can have ends that are strengthened with tape, glue, plastic, rubber, metal or other substance more stiff than the lace material.

In other embodiments, the present technology is directed to a method of lacing an article having a first side and a second side opposite the first side and a through hole therethrough, the method comprising inserting a lace through a first fascia at a first point on the through hole on the first side of a body, and out of a second fascia at a second point on the through hole on the second side of the body.

In other embodiments, the present technology is directed to an article comprising a body with two or more through holes covered by a first facia on one side and a second facia on the other side. The facia is opaque and thin enough to provide for the transmission of a lace through the facia portions that lie over the holes in the body through user pressure without the need for any tools. The lace can have ends that are strengthened with tape, glue, plastic, rubber, metal or other substance more stiff than the lace material.

In other embodiments, the present technology is directed to a method of lacing an article comprising a body with at least two through holes that are covered by a first fascia on one side and a second fascia on the other side. The fascia is opaque and thin enough to provide for the transmission of a lace through the fascia portions that lie over the holes in the body through user pressure without the need for any tools. The method comprising pushing a lace through the external side of the first fascia at the sight of a hole within the body, pushing the lace through the hole and pushing the lace through the internal side of the second fascia at the exit of the hole. These steps can be repeated by the user in the same or different holes.

### DESCRIPTION OF THE DRAWINGS

FIG. 1 shows an exploded view of an article in accordance with certain embodiments herein.

FIG. 2 shows an elevational view of a body in accordance with certain embodiments herein.

FIG. 3 shows an elevational view of an article in accordance with certain embodiments herein.

### DETAILED DESCRIPTION

As used herein, “fascia” can mean a substantially flat piece of material for covering all or parts of a body. The fascia can be of any depth (thickness) that allows for a user to punch through it with or without a tool and in various embodiments can be about 0.0001 mm to about 10.0 mm, about 0.1 mm to about 2 mm or about 0.5 mm to 1 mm. The fascia can be adapted to cover some or all of the body.

As used herein, “body” can mean an article comprising cardboard, paper, wood, metals, rubbers or plastics, or any combination of those. It can be of any shape, either regular or irregular. The body comprises at least a single, preformed through-hole.

As used herein, “substrate” and “article” can mean the article through which the lace is inserted, and includes the body as well as any fascia that overlays any portion of the body.

As used herein, “lace” or “lacing” can refer to the actual material that is inserted into the article to provide the patterns discussed herein, and in various embodiments can mean any such material that comprises cotton, jute, fiber, wool, rubber, metal, plastic, glass, leather, string, twine, thread, yarn, hair, floss, wire, plant fiber (e.g., burlap, hemp, jute, wood pulp, flax, vine, nettle, bamboo, leaf, seed, straw), paper, fiberglass, cordage, rope cord or strip. Nails can also be used to push through fascia and into a through-hole in a body. Lacing can then be done around the nails. In certain embodiments, lacing can also be understood to mean wires or other material laced through the fascia and body as a guide as in a wire guide.

### External Portion

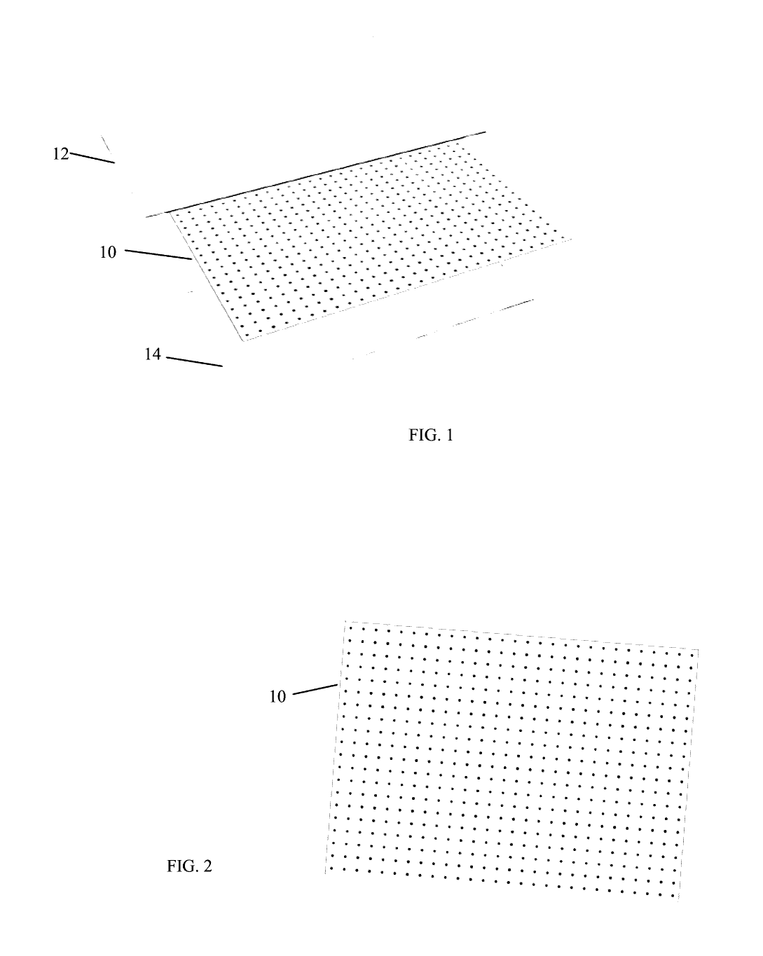

In certain embodiments, the external portion of this technology appears as a solid article that can be opaque, translucent or transparent. It has no apparent holes or perforations above the holes found in the body. As shown in the example of FIG. 1, this appearance is caused by a fascia 12, 14 that is adhered to the body 10. As used herein, “external portion” means that at least part of the portion is visible and external to the body.

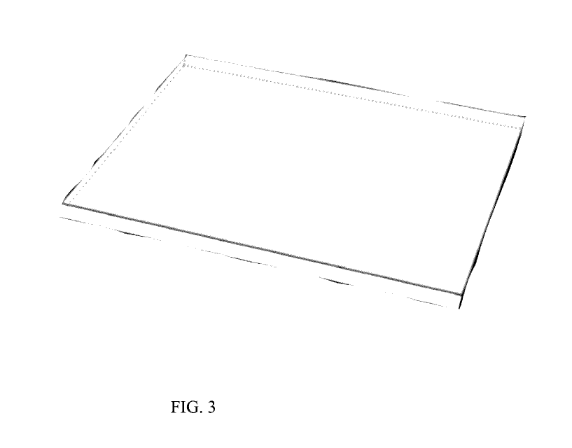

In certain embodiments, the external portion can be of any shape or size. For example, as seen in FIG. 3, the external portion of the current technology appears as a substantially planar, rectangular and solid board. The shape and size can provide for the fascia to cover at least that portion of the body that has one or more holes. In certain embodiments the fascia substantially covers the entire body and is of corresponding shape and size.

### Internal Portion

The internal portion of this technology is a body with one or more holes. The hole can be formed using a drill, laser, awl, punch or other mechanism capable of producing a hole through the body material. In certain embodiments, the body has an array of holes. A hole can be of any size that is smaller than the body. The hole can be of any shape including circular or square. The body material can be cardboard, paper, wood, metal, plastic, rubber, natural or synthetic polymeric material or any combination of those. The body can be of any shape, open or closed. For example, as seen in FIG. 2, in certain embodiments the internal portion 10 is substantially planar and rectangular. As seen in FIG. 1, in certain embodiments the body 10 depth is substantially less than its width and length. The example in FIG. 2 has a body 10 with an array of 20 holes wide and 28 holes in length. In various embodiments, the depth of body 10 can be about 1 mm to about 600 mm, or about 2 mm to about 200 mm or about 3 mm to about 100 mm.

The example of the current technology shown in FIG. 1 is an exploded view of the embodiment shown in FIG. 3. In this embodiment, the fascia 12, 14 are substantially the same size and shape of the body 10. Hence, when the fascia 12, 14 lie on top of the body 10, all of the holes in the body 10 are covered. This example also shows an opaque fascia that prevents a user from seeing the holes in the body 10 at a first glance.

In certain embodiments herein, the present technology is directed to methods of lacing a lace card, placing wire through a wire guide or inserting nails, dowels or pins through the fascia into one or more holes to lace around. These dowels may be of metal, wood, plastic rubber or other material sufficient to be used as a mechanism around which a lace may be wrapped.

Although the present technology has been described in relation to particular embodiments thereof, these embodiments and examples are merely exemplary and not intended to be limiting. Many other variations and modifications and other uses will become apparent to those skilled in the art. The present technology should, therefore, not be limited by the specific disclosure herein, and may be embodied in other forms not explicitly described here, without departing from the spirit thereof.

What is claimed is:

1. An article comprising:
a first fascia and a second fascia; each of the first fascia and the second fascia being thin enough to provide for the transmission of a lace therethrough by user pressure without the need for any tools; each of the first and the second fascia being disposed at least partially over a body comprising a hole.

2. An article comprising:
a body comprising a hole;
a fascia covering the hole, the fascia having a depth of small enough dimension to allow a user to push a lace through the fascia.

3. A method of lacing comprising:
pushing a lace through a fascia covering a hole in a body.

4. A method of lacing an article having a first side and a second side opposite the first side and a through hole, the method comprising inserting a lace through a first fascia at a first point on the through hole on the first side of a body, and out of a second fascia at a second point on the through hole on the second side of the body.

5. A method of lacing an article comprising:
inserting a pin through a fascia, the fascia covering a hole in a body; and
wrapping a lace around the pin.
